(19) United States
(12) Patent Application Publication
(10) Pub. No.: US 2013/0055697 A1
(43) Pub. Date: Mar. 7, 2013

(54) FLUID COMPOSITION ANALYSIS MECHANISM, CALORIFIC VALUE MEASUREMENT DEVICE AND POWER PLANT

(71) Applicants: Yoshihiro Deguchi, Tokushima-shi (JP); Yosuke Kitauchi, Tokyo (JP); Mitsuru Inada, Tokyo (JP)

(72) Inventors: Yoshihiro Deguchi, Tokushima-shi (JP); Yosuke Kitauchi, Tokyo (JP); Mitsuru Inada, Tokyo (JP)

(73) Assignee: MITSUBISHI HEAVY INDUSTRIES, LTD., Tokyo (JP)

(21) Appl. No.: 13/482,565

(22) Filed: May 29, 2012

(30) Foreign Application Priority Data
Sep. 1, 2011 (JP) 2011-190702

(51) Int. Cl. G01K 17/00; F02C 9/00; G01J 3/44

(52) U.S. Cl. 60/39.24; 356/301; 374/31; 374/E17.001

(57) ABSTRACT

A fluid composition analysis mechanism includes a light source for configured to irradiate excitation light to a sample fluid at a measurement position; a light receiving unit arranged on an extended line of the excitation light for configured to receive and disperse Raman scattering light generated from the sample fluid irradiated with the excitation light; a Raman scattering light collection optical system arranged on an optical path for the excitation light or on the extended line of the excitation light configured to collect the Raman scattering light generated at the measurement position and to cause the condensed Raman scattering light to be incident on the light receiving unit; a calculation unit configured to calculate a composition of the sample fluid based on an output of the light receiving unit; and a light shielding member arranged on the optical path or on the extended line of the excitation light.

### BACKGROUND OF THE INVENTION

1. Field of the Invention

The present invention relates to a fluid composition analysis mechanism, a calorific value measurement device, and a power plant. More particularly, the present invention relates to noise rejection when a composition and a calorific value of a fuel gas supplied to a gas turbine are measured. Priority is claimed on Japanese Patent Application No. 2011-190702, filed Sep. 1, 2011, the contents of which is incorporated herein by reference.

2. Description of Related Art

In general, in a gas-fired power plant in which a fuel gas, which is mainly a low calorific value gas, such as a BFG (Blast Furnace Gas), is burned by a combustor of a gas turbine, the BFG has a low calorific value. For this reason, a fuel gas in which a gas having a higher calorific value than the BFG, such as a COG (Cokes Oven Gas), is mixed to increase a calorific value on the order of for example 1000 kcal/m³N has been used.

In the fuel gas guided to the combustor, a low calorific value gas and a high calorific value gas are mixed. For this reason, when a mixing ratio of the low calorific value gas and the high calorific value gas is changed, a property of the combustor or an output of the fuel gas is likely to be changed. In order to suppress the change in the property of the combustor or the output of the gas turbine, the calorific value of the low calorific value gas is measured before the low calorific value gas is supplied to the combustor. According to the measurement result of the calorific value, an amount of flow of the high calorific value gas is controlled and the calorific value of the fuel gas supplied to the combustor is controlled. There are a combustion-type and a type using Raman scattering light disclosed in Japanese Unexamined Patent Application, First Publication No. 2002-286644 and Japanese Unexamined Patent Application, First Publication No. 2005-24250 to measure such a calorific value.

In a combustion-type calorific value measurement device, a fuel gas is sampled and burned using a burner, and a difference between a temperature of the combustion gas and a temperature of combustion air in an entrance of the burner is used to measure a calorific value. For this reason, time is required for processes before measurement, such as gas sampling or dehumidification. Further, a response of the device at the time of measurement is relatively late in the order of minutes. Accordingly, the device is not suitable for rapid control of the calorific value of the fuel gas supplied to the gas turbine.

In a calorific value measurement device in the type using Raman scattering light disclosed in Japanese Unexamined Patent Application, First Publication No. 2002-286644 and Japanese Unexamined Patent Application, First Publication No. 2005-24250, the response of the device at the time of measurement is relatively fast. Accordingly, the device may be applied to rapid control of the calorific value of the fuel gas supplied to the gas turbine.

However, with the inventions disclosed in Japanese Unexamined Patent Application, First Publication No. 2002-286644 and Japanese Unexamined Patent Application, First Publication No. 2005-24250, it is not possible to measure the Raman scattering light with a sufficient SN ratio. As a result, a measurement time is likely to take several tens of seconds. More specifically, excitation light is generally incident on a fuel gas via a measurement window. This measurement window is often contaminated by foreign matters such as soot contained in the fuel gas. In this case, noise light is generated by the excitation light being irradiated to the foreign matters attached to the measurement window. Also, as this noise light is incident on a detector, weak Raman scattering light cannot be measured with a high SN ratio and the measurement takes a long time. In principle, when an intensity of incident excitation light increases, signal intensity also increases. However, a device cost becomes higher and noise increases.

### SUMMARY OF THE INVENTION

The present invention provides a fluid composition analysis mechanism, a calorific value measurement device, and a gas-fired power plant that are capable of increasing operation reliability or reducing an operation cost in a gas-fired power plant by rapidly measuring a calorific value of a fuel gas supplied to a combustor.

A fluid composition analysis mechanism according to a first aspect of the present invention includes: a light source configured to irradiate excitation light to a sample fluid at a measurement position; a light receiving unit arranged on an extended line of the excitation light and configured to receive and disperse Raman scattering light generated from the sample fluid irradiated with the excitation light; a Raman scattering light collection optical system arranged on an optical path for the excitation light or on an extended line of the excitation light and configured to collect the Raman scattering light generated at the measurement position and to cause the Raman scattering light to be incident on the light receiving unit; a calculation unit configured to calculate a composition of the sample fluid based on an output of the light receiving unit; and a light shielding member arranged on the optical path for the excitation light or on the extended line of the excitation light.

According to this configuration, when the excitation light is incident on the sample fluid, Raman scattering lights having different wavelengths according to components in the sample fluid are generated. The components in the sample fluid is capable of being known from the wavelengths disperse from the Raman scattering light. Also, it is possible to obtain the composition of the sample fluid based on the dispersing wavelengths and calculate the calorific value from the composition of the sample fluid.

In the fluid composition analysis mechanism according to the first aspect of the present invention, the light receiving unit is arranged on the extended line of the excitation light. Further, the Raman scattering light collection optical system is arranged on the optical path for the excitation light or on the extended line of the excitation light. This Raman scattering light collection optical system collects and incidents the Raman scattering light generated at the measurement position to the light receiving unit. The Raman scattering light has an intensity distribution in which the intensity is strong in a direction parallel to a traveling direction of the excitation light and weak in a direction perpendicular to the traveling direction. Thus, it is possible to increase the intensity of the Raman scattering light guided to the light receiving unit by providing the Raman scattering light collection optical system in the direction in which the intensity of the Raman scattering light is high.

Further, in the fluid composition analysis mechanism according to the first aspect of the present invention, the light shielding member is arranged on the optical path for the excitation light or on the extended line of the excitation light. Noise light that obstructs measurement of the Raman scattering light is mainly generated from a substance irradiated with excitation light. It is possible to effectively prevent noise light generated on the optical path for the excitation light from reaching the light receiving unit via the Raman scattering light collection optical system by arranging the light shielding member on the optical path for the excitation light or on the extended line of the excitation light. As a result, it is possible to measure the Raman scattering light with a high SN ratio and calculate the composition and the calorific value of the sample fluid with a high response.

A fluid composition analysis mechanism according to a second aspect of the present invention further includes a first measurement window arranged on the optical path for the excitation light and configured to guide the excitation light to an area in which the sample fluid flows; and a second measurement window arranged on the optical path for the excitation light or on the extended line of the excitation light and configured to guide the Raman scattering light generated at the measurement position to the Raman scattering light collection optical system arranged outside the area in which the sample fluid flows. The light shielding member includes a first light shielding member arranged on the side of the light receiving unit in comparison to a surface of the second measurement window exposed to the sample fluid; and a second light shielding member arranged on the side of the light receiving unit in comparison to the first light shielding member and configured to have an outline coincides with the first light shielding member when viewed from the measurement position.

According to this configuration, noise light is generated from a position which is the surfaces of the first measurement window and the second measurement window exposed to the sample fluid, and which is a position irradiated with the excitation light. Also, since the noise light is effectively cut by the first light shielding member provided in the vicinity of the second measurement window, it is possible to measure the Raman scattering light with a high SN ratio. Further, since the second light shielding member configured to have the outline coincides with the first light shielding member when viewed from measurement position is provided, it is possible to measure the Raman scattering light with a higher SN ratio. More specifically, the second light shielding member has an outline coincides with the first light shielding member when viewed from the measurement position. Accordingly, the second light shielding member does not shield amount of the Raman scattering light generated from the measurement position which is greater than amount of the Raman scattering light generated from the measurement position shielded by the first light shielding member. As a result, more noise light may be cut without degrading the signal intensity of the Raman scattering light, thus measuring the Raman scattering light with a higher SN ratio.

A fluid composition analysis mechanism according to a third aspect of the present invention further includes a first measurement window arranged on the optical path for the excitation light and configured to guide the excitation light to an area in which the sample fluid flows; and a second measurement window arranged on the optical path for the excitation light or on the extended line of the excitation light and configured to guide the Raman scattering light generated at the measurement position to the Raman scattering light collection optical system arranged outside the area in which the sample fluid flows. The light shielding member includes a first light shielding member arranged on the side of the light receiving unit in comparison to a surface of the second measurement window exposed to the sample fluid; and a second light shielding member arranged between the first measurement window and the second measurement window and configured to shield portions other than the optical path for the excitation light.

According to this configuration, noise light is generated from a position which is the surfaces of the first measurement window and the second measurement window exposed to the sample fluid, and which is a position irradiated with the excitation light. Since the noise light is effectively cut by the first light shielding member provided in the vicinity of the second measurement window, it is possible to measure the Raman scattering light with a high SN ratio. Further, since the second light shielding member arranged between the first measurement window and the second measurement window for shielding portions other than the optical path for the excitation light is provided, it is possible to measure the Raman scattering light with a higher SN ratio. More specifically, since the second light shielding member does not shield the optical path for the excitation light, the second light shielding member does not obstruct generation of the Raman scattering light. In addition, the second light shielding member is capable of effectively preventing noise light generated from a position which is the surface of the first measurement window exposed to the sample fluid, and is a position irradiated with the excitation light, from being incident on the light receiving unit. Thus, since the noise light is cut without degrading the signal intensity of the Raman scattering light, it is possible to measure the Raman scattering light with a higher SN ratio.

A fourth aspect of the present invention is the fluid composition analysis mechanism according to the first aspect of the present invention, in which a focus of the excitation light is located on the surface of the member contacting the sample fluid.

According to this configuration, it is possible to minimize an area which is a surface of the member contacting the sample fluid, and which is a portion irradiated with the excitation light. The noise light is mainly generated from the portion irradiated with the excitation light. However, according to this configuration, the area in which the noise light is generated may be reduced. Thus, it is possible to more easily and effectively reduce the noise light using the light shielding member and measure the Raman scattering light with a higher SN ratio.

In a fifth aspect of the present invention, the fluid composition analysis mechanism according to the first aspect of the present invention includes a reflector provided perpendicularly to the optical path for the excitation light on the optical path and configured to reflect the excitation light.

According to this configuration, the excitation light irradiated from the light source and the excitation light reflected by the reflector are irradiated to the sample fluid in the measurement area. Accordingly, it is possible to improve the intensity of the Raman scattering light incident on the light receiving unit. Thus, it is possible to calculate the composition and the calorific value with a high response and high accuracy.

Further, a calorific value measurement device according to a sixth aspect of the present invention includes a fluid composition analysis mechanism according to the first to fifth aspects of the present invention, and a calorific value calculation mechanism configured to calculate a calorific value of the sample fluid based on information of the composition of the sample fluid output by the fluid composition analysis mechanism.

The fluid composition analysis mechanism according to the first to fifth aspects of the present invention are capable of analyzing the composition of the fluid in a short amount of time. Accordingly, in a calorific value measurement device using the same, it is possible to rapidly calculate the calorific value of the sample fluid.

Furthermore, a power plant according to a seventh aspect of the present invention is operable with a fuel gas as a fuel, and includes a calorific value measurement device according to the present invention, and a control device configured to control operation of the power plant based on information of the calorific value of the fuel gas output by the calorific value measurement device. At least part of the fuel gas is guided as the sample fluid to the calorific value measurement device.

In the calorific value measurement device according to the sixth aspect of the present invention, it is possible to rapidly measure the calorific value of the fuel gas supplied to the power plant. Thus, according to this configuration, it is possible to rapidly control the calorific value of the fuel gas supplied to the power plant and control excessive supply of a high calorific value fuel gas. It is also possible to operate the power plant using only a fuel gas having a low calorific value without using a fuel gas having a high calorific value. Accordingly, it is possible to reduce an operation cost of the power plant.

In the fluid composition analysis mechanism described above, it is possible to increase the intensity of the Raman scattering light guided to the light receiving unit by providing the Raman scattering light collection optical system in a direction in which the intensity of the Raman scattering light is high. It is also possible to effectively prevent the noise light generated on the optical path for the excitation light from being delivered to the light receiving unit via the Raman scattering light collection optical system by arranging the light shielding member on the optical path for the excitation light or on the extended line of the excitation light. Accordingly, the intensity of the Raman scattering light received by the light division means may be increased and noise may be reduced. Accordingly, it is possible to calculate the calorific value of the sample fluid with a high response. Thus, it is possible to improve responsiveness of the calorific value measurement device including this fluid composition analysis mechanism.

### BRIEF DESCRIPTION OF THE DRAWINGS

FIG. 1 is a schematic configuration diagram showing a gas-fired power plant including a calorific value measurement device according to a first embodiment of the present invention.

FIG. 2 is a schematic configuration diagram of a measurement unit according to the first embodiment of the present invention.

FIG. 3 is a diagram showing optical paths of noises generated from a measurement window in the measurement unit according to the first embodiment of the present invention.

FIG. 4A is a diagram showing a situation in which noise light generated from the measurement window is shielded.

FIG. 4B is a diagram showing a situation in which noise light generated from the measurement window is shielded.

FIG. 4C is a diagram showing a situation in which noise light generated from the measurement window is shielded.

FIG. 5 is a graph showing a relationship between a Raman shift amount of each component and a laser wavelength or a Raman scattering light wavelength.

FIG. 6 is a graph showing a relationship with signal intensity (including Raman scattering light and noise) according to presence or absence of light shielding members related to an embodiment of the present invention.

FIG. 7 is a graph showing a relationship between Raman scattering light intensity of each component and a wavelength of each component.

FIG. 8 is a configuration diagram in which a light shielding member is arranged between two measurement windows of an excitation light incident unit and a reflection unit in a measurement unit according to a second embodiment of the present invention.

### PREFERRED EMBODIMENTS

### First Embodiment

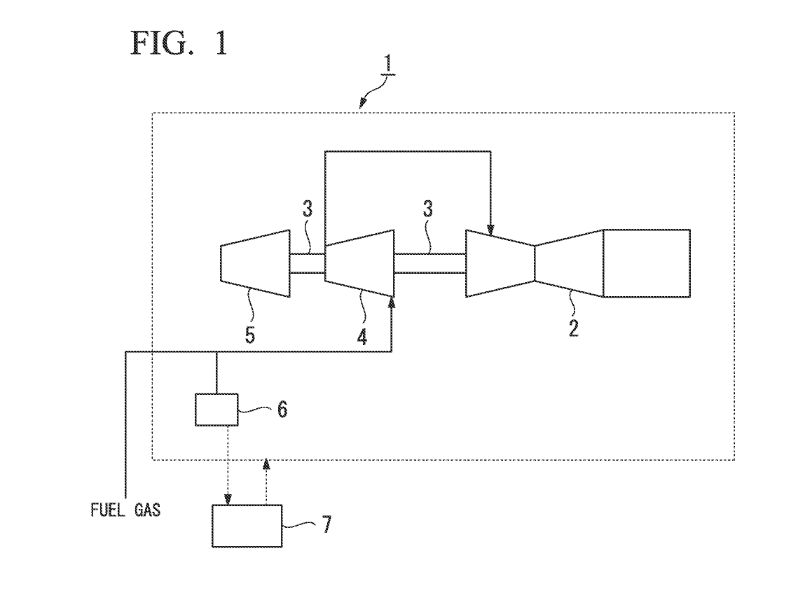

FIG. 1 is a schematic configuration diagram showing an example of a gas-fired power plant including a calorific value measurement device according to a first embodiment of the present invention.

As shown in FIG. 1, a BFG-fired composite power plant (a gas-fired power plant) 1 includes a gas turbine 2 for performing rotational driving by burning a fuel gas, a gas compressor 4 for compressing the fuel gas, a steam turbine 5 rotationally driven by steam, a generator (not shown) for generating electricity, and a calorific value measurement device 6 configured to measure a calorific value of the fuel gas.

In the embodiment, a description will be given using a one-shaft BFG-fired composite power plant. However, the embodiment of the present invention is not limited to the one-shaft composite power plant and may be applied to a power plant for only a gas turbine or a two-shaft or multi-shaft power plant.

The calorific value measurement device 6 is a device for measuring the calorific value of the fuel gas (a sample fluid) using Raman scattering light. Information of the calorific value obtained by the calorific value measurement device 6 is input to a control device 7. The control device 7 controls operation of the BFG-fired composite power plant 1 based on this information. On the other hand, the fuel gas whose calorific value has been measured by the calorific value measurement device 6 is guided to the gas compressor 4.

The gas compressor 4 is an apparatus for compressing the fuel gas. A rotational shaft 3 is connected to the gas compressor 4. The rotational shaft 3 is connected to the gas turbine 2 and the steam turbine 5 via a gearing, which is not shown.

The fuel gas compressed by the gas compressor 4 is guided to the gas turbine 2.

The gas turbine 2 includes an air compressor, a turbine, and an air compressor, which are not shown. The air compressor sends high-pressure air to the combustor. The combustor generates a combustion gas by burning the mixture of high-pressure air and the fuel gas. The turbine is provided coaxially with the air compressor and converts energy of the combustion gas discharged from the combustor into rotational energy. Part of this rotational energy is used for the air compressor to produce the high-pressure air, and the remaining energy is used to rotationally drive the rotational shaft 3.

A generator is connected to an end of the rotational shaft 3. Therefore, the generator generates electricity by the turbine rotating the rotational shaft 3. Further, the rotation of the rotational shaft 3 rotationally drives the gas compressor 4 via the gearing as described above.

The combustion gas passing through the turbine is guided to an exhaust gas recovery boiler (not shown). The exhaust gas recovery boiler is an apparatus configured to generate steam by means of heat of the combustion gas guided from the gas turbine 2. The combustion gas used to generate the steam in the exhaust gas recovery boiler is discharged from a chimney (not shown) to the outside of the composite power plant 1.

In the exhaust gas recovery boiler, the steam generated by a high-temperature combustion gas guided from the gas turbine 2 is supplied to the steam turbine 5. The steam turbine 5 is connected to the rotational shaft 3 same as the gas turbine 2, and constitutes a so-called one-shaft combined system. The combined system is not limited to the one-shaft combined system, but may be a different-shaft combined system.

The driving force of the rotational shaft 3 rotationally driven by the turbine is increased by the steam turbine 5. Accordingly, a power generation amount of the generator to which the rotational shaft 3 is connected increases. Further, the gas compressor 4 is rotationally driven via the gearing connected to the rotational shaft 3.

The steam that rotationally drives the steam turbine 5 is guided to a steam condenser (not shown). The steam that rotationally drives the steam turbine 5 is cooled and returned to water by the steam condenser. The water returned by the steam condenser is guided to the exhaust gas recovery boiler.

Next, the calorific value measurement device according to the first embodiment of the present invention will be described.

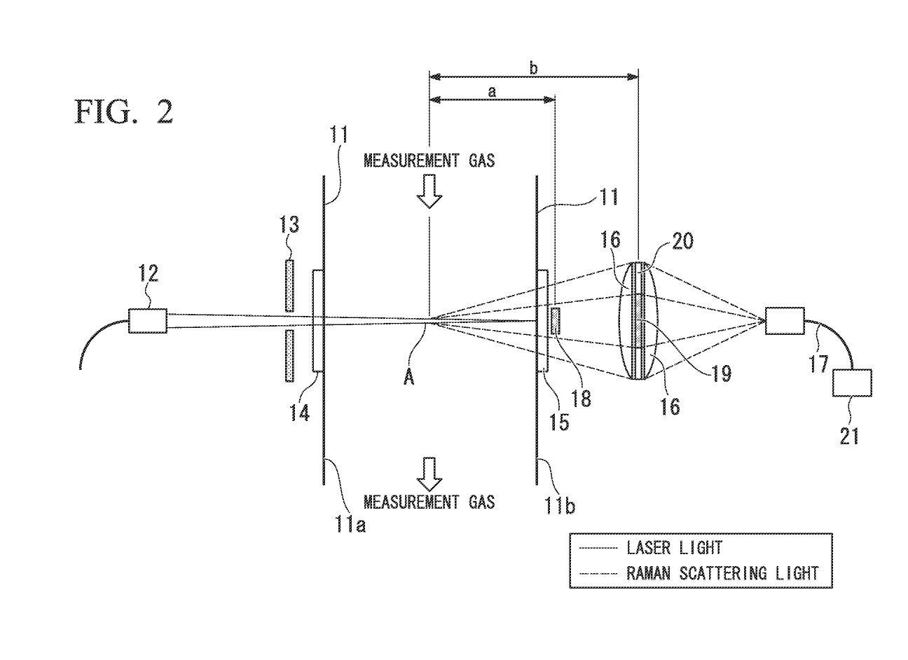

FIG. 2 shows an example of a schematic configuration diagram of a measurement unit. The measurement unit is a device configured to measure a composition and a calorific value of the fuel gas using the Raman scattering light.

The measurement unit includes a casing 11 for introduction of a measurement gas. In the casing 11, an inlet through which the fuel gas is introduced and an outlet through which the fuel gas passing through a measurement area is derived from the casing 11 are opened. Further, the measurement unit includes an optical fiber for light transmission 12 (a light source) for causing an excitation light having a certain wavelength to be incident on the fuel gas in the measurement area of the casing 11.

A first measurement window 14 through which the excitation light passes is provided coaxially with the excitation light on a sidewall 11a of the casing 11 on the side on which the optical fiber for light transmission 12 is provided. Further, a diaphragm 13 that passes the excitation light is provided coaxially with the excitation light between the optical fiber for light transmission 12 and the first measurement window 14.

A second measurement window 15 is provided coaxially with and perpendicularly to the excitation light on a sidewall 11b opposite to the sidewall 11a of the casing 11 on the side on which the optical fiber for light transmission 12 is provided. The second measurement window 15 has a property that reflects the excitation light and transmits the Raman scattering light. Further, the second measurement window 15 vertically reflects the incident excitation light into the casing 11 by the optical fiber for light transmission 12, and transmits the Raman scattering light. Further, an optical fiber for light reception 17 (a light receiving unit) for receiving the Raman scattering light is provided coaxially with an extended line of the excitation light on the extended line of the excitation light.

Further, a condenser lens 16 (a Raman scattering light collection optical system) including two plano-convex lenses is provided coaxially with the extended line of the excitation light between the second measurement window 15 and the optical fiber for light reception 17. Also, a Raman scattering light from a measurement point A that is a position in which an irradiated excitation light is received in a space sandwiched between the two measurement windows 14 and 15 is collected on the optical fiber for light reception 17. The condenser lens 16 includes a filter 20 for transmitting only a wavelength of the Raman scattering light.

A spectral calculation means 21 (a calculation unit) is connected to the optical fiber for light reception 17. The spectral calculation means 21 disperses the Raman scattering light detected by the optical fiber for light reception 17 and calculates a composition and a calorific value of the fuel gas from Raman scattering light intensities of respective components.

A first light shielding member 18 (a light shielding member) is provided outside the second measurement window 15. A second light shielding member 19 is provided inside the condenser lens 16. The first light shielding member 18 and the second light shielding member 19 have circular shapes, are arranged coaxially with the excitation light or the extended line of the excitation light and have a function of not transmitting light in areas in which the light shielding members are installed. Further, the first light shielding member 18 and the second light shielding member 19 are arranged to have the same outlines when viewed from the measurement point A. More specifically, it is assumed that a radius of the first light shielding member 18 is R18 and a radius of the second light shielding member 19 is R19. Further, as shown in FIG. 2, when a distance between the measurement point A and the first light shielding member 18 in an incident direction is a and a distance between the measurement point A and the second light shielding member 19 in the incident direction is b, there is a relationship of R18/R19=a/b. That is, the second light shielding member 19 has a larger radius than the first light shielding member 18. For example, when the radius of the first light shielding member 18 is 5 mm, the distance a is 50 mm, and the distance b is 100 mm, the radius of the second light shielding member 19 is 10 mm.

Next, operation of the calorific value measurement device according to the first embodiment of the present invention will be described.

A process of measuring the calorific value of the fuel gas in the calorific value measurement device according to the first embodiment of the present invention will be described. First, the inlet and the outlet provided in the casing 11 are opened, and the fuel gas is introduced as the sample fluid into the measurement area of the casing 11.

Next, an excitation light having a certain wavelength is sent by the optical fiber for light transmission 12. The excitation light sent from the optical fiber for light transmission 12 is transmitted through the diaphragm 13 and the measurement window 14 and irradiated the fuel gas introduced into the measurement area of the casing 11, particularly, on the fuel gas flowing through the measurement point A. Further, the excitation light reaching the measurement window 15 is vertically reflected in the same direction as the incident direction and irradiated to the fuel gas flowing through the measurement point A again. The intensity of the excitation light irradiated to the fuel gas flowing through the measurement point A may be increased by this configuration. Accordingly, the intensity of the Raman scattering light generated at the measurement point A increases to thereby shorten a time necessary for measurement. As a result, it is possible to calculate the composition and the calorific value of the sample fluid with a high response.

The excitation light incident on the fuel gas in the measurement area from the optical fiber for light transmission 12 causes Raman scattering light having various wavelengths. The Raman scattering light is scattering light that causes a different wavelength according to vibrational energy specific to each component in the fuel gas. Further, the intensity of the Raman scattering light is known to be high in a forward direction of an incident axial direction of the excitation light (hereinafter referred to as “forward Raman scattering light”) and a backward direction (hereinafter referred to as “backward Raman scattering light”).

The fuel gas at the measurement point A is irradiated with the excitation light from the optical fiber for light transmission 12 and the forward Raman scattering light is generated. Further, the fuel gas at the measurement point A is irradiated with the excitation light reflected by the measurement window 15 and the backward Raman scattering light is generated. The forward Raman scattering light and the backward Raman scattering light transmit the measurement window 15 and are guided to the outside of the casing 11. The Raman scattering light is generated from the measurement point A, then after light other than the Raman scattering light is removed by the filter 20, and is collected and incident on the optical fiber for light reception 17 by the condenser lens 16.

The Raman scattering light collected by the condenser lens 16 is guided to the spectral calculation means 21 by the optical fiber for light reception 17, and dispersed into Raman scattering light having wavelengths according to the components of the fuel gas. Further, the spectral calculation means 21 calculates the composition and the calorific value of the fuel gas from intensities of the dispersing Raman scattering light having the respective wavelengths. A mechanism for calculating the composition and the calorific value of the fuel gas will be described in detail later.

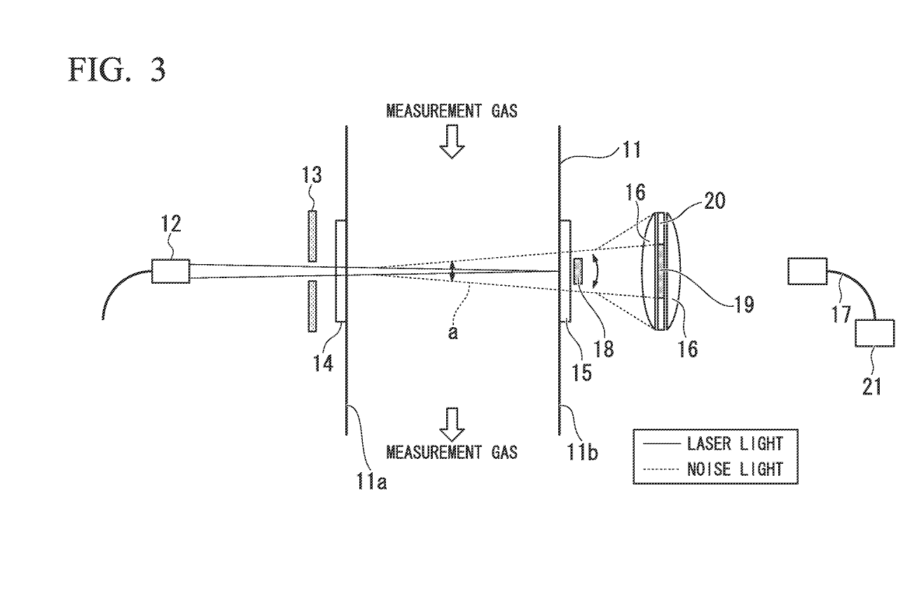

Next, a mechanism for removing noise light generated from the first measurement window 14 and the second measurement window 15 will be described with reference to FIG. 3. When the first measurement window 14 and the second measurement window 15 are contaminated due to, for example, the fuel gas, noise light is generated in excitation light irradiation portions (central portions) in the first measurement window 14 and the second measurement window 15. The Raman scattering light is weak, and measurement accuracy is degraded when the noise light is measured. For this reason, the mechanism for removing the noise light is important in measurement.

The first measurement window 14 is arranged distant from the condenser lens 16 in comparison to the measurement point A. On the other hand, the second measurement window 15 is arranged closer to the condenser lens 16 in comparison to the measurement point A. Because of this, viewing angles of a noise generation portion of the first measurement window 14 and viewing angles of a noise generation portion of the second measurement window 15 are different when viewed from the condenser lens 16. A viewing angle α from the noise generation portion of the first measurement window 14 is small and a viewing angle β from the noise generation portion of the second measurement window 15 is great. In the embodiment, since two types: the first light shielding member 18 and the second light shielding member 19, are provided, the noise light from the first measurement window 14 is efficiently removed by the second light shielding member 19. On the other hand, the noise light from the second measurement window 15 is efficiently removed by the first light shielding member 18.

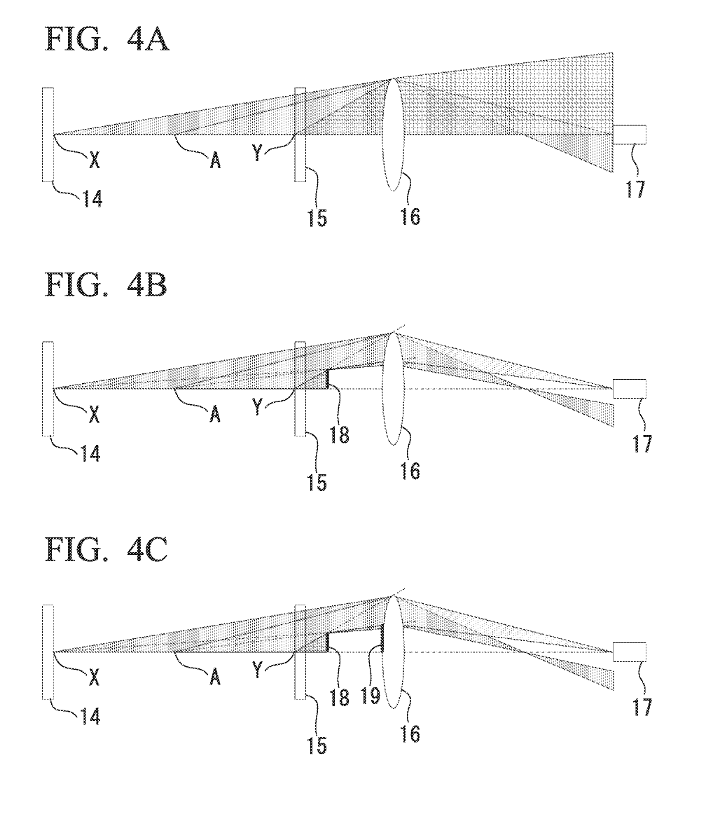

This will be described with reference to FIGS. 4A to 4C. As shown in FIG. 4A, when the first light shielding member 18 and the second light shielding member 19 are not provided, noise light generated from a position (hereinafter referred to as “noise generation point Y”) irradiated with the excitation light on a surface of the second measurement window 15 on the measurement gas side is incident on the condenser lens 16 without being shielded by the light shielding member. Here, the condenser lens 16 is configured to collect the light from the measurement point A on the optical fiber for light reception 17. Accordingly, a noise light generated from the noise generation point Y, which is the position close to the condenser lens 16 in comparison to the measurement point A, is not collected to the optical fiber for light reception 17. However, since noise light at an angle almost parallel to the excitation light among noise light generated from the noise generation point Y passes through the vicinity of an optical axis of the condenser lens 16, an amount of turning due to refraction is small and the noise light is incident on the optical fiber for light reception 17.

Further, noise light generated from a position (hereinafter referred to as “noise generation point X”) irradiated with the excitation light on a surface of the first measurement window 14 on the measurement gas side is incident on the condenser lens 16 without being shielded by the light shielding member. Here, the condenser lens 16 is configured to collect the light from the measurement point A on the optical fiber for light reception 17. Accordingly, the noise light generated from the noise generation point X that is distant in comparison to the measurement point A when viewed from the condenser lens 16 is collected in a position between the condenser lens 16 and the optical fiber for light reception 17, and is not collected on the optical fiber for light reception 17. However, since noise light at an angle almost parallel to the excitation light among the noise light generated from the noise generation point X passes through the vicinity of an optical axis of the condenser lens 16, an amount of turning due to refraction is small and the noise light is incident on the optical fiber for light reception 17.

Next, FIG. 4B shows a case in which only the light shielding member 18 is provided. In order to efficiently shield the noise light, the light shielding member may be provided in the vicinity of a position in which the noise light is generated. With this configuration, the noise light irradiated in a wide angle range may be removed even using a small light shielding member. As shown in FIG. 4B, the first light shielding member 18 is provided in the vicinity of the second measurement window 15 on the extended line of the excitation light. Accordingly, noise light from the noise generation point Y located on the surface of the second measurement window 15 at the side of measurement gas may be efficiently shielded with a small area. In particular, the noise light incident on the optical fiber for light reception 17 at an angle almost parallel to the excitation light among the noise light generated from the noise generation point Y is reliably shielded by the first light shielding member 18, thus preventing the noise light from being incident on the optical fiber for light reception 17. Since the noise light is shielded by the first light shielding member 18 having the small area, Raman scattering light that is a measurement target is not greatly shielded by the first light shielding member.

On the other hand, the noise light from the noise generation point X may also be effectively shielded by the first light shielding member 18. That is, since the first light shielding member 18 is away from the noise generation point X, the noise light from the noise generation point X cannot be shielded in a wide angle range. However, the noise light reaching the optical fiber for light reception 17 through the condenser lens 16 among the noise light generated from the noise generation point X is only noise light at an angle almost parallel to the excitation light. Since the first light shielding member 18 is provided on the extended line of the excitation light, noise light that becomes an actually obstacle, may be efficiently shielded in measurement of the Raman scattering light. Since the noise light may be shielded by the first light shielding member 18 having the small area, the Raman scattering light, which is the measurement target, is not greatly shielded by the first light shielding member.

Thus, in the present embodiment, the first light shielding member 18 is arranged on the extended line of the excitation light based on a new insight that strong noise light is generated in a portion irradiated with the excitation light on the surfaces of the first measurement window 14 and the second measurement window 15 at the side of the fuel gas, it is possible to efficiently shield the noise light. As the first light shielding member 18 is arranged, the forward Raman scattering light and the backward Raman scattering light having a high intensity are collected and guided to the spectral calculation means 21, and the noise light may be shielded without greatly shielding the Raman scattering light. Accordingly, it is possible to measure the Raman scattering light with a high SN ratio and to shorten time necessary for measurement. As a result, it is possible to calculate the composition and the calorific value of the sample fluid with a high response.

Next, FIG. 4C shows a case in which the second light shielding member 19 is provided in addition to the first light shielding member 18. As shown in FIG. 4C, the second light shielding member 19 is provided on the extended line of the excitation light on the side of the optical fiber for light reception 17 in comparison to the first light shielding member 18. Further, as described above, the second light shielding member 19 is arranged so as to have the same outline with the first light shielding member 18 when viewed from the measurement point A. Because of this, the second light shielding member 19 does not shield the Raman scattering light that is generated at the measurement point A and directed to the condenser lens 16, in a wider range than that in which the first light shielding member 18 shields the light.

Also, in the second light shielding member 19, it is possible to further reduce the noise light from the noise generation point X. As described above, noise light actually incident on the optical fiber for light reception 17 through the condenser lens 16 among the noise light from the noise generation point X is shielded by the first light shielding member 18. However, noise light having a slightly larger angle than noise light shielded by the first light shielding member 18 is likely to reach the vicinity of the optical fiber for light reception 17 and adversely affect the measurement. The second light shielding member 19 shields this noise light without newly shielding the Raman scattering light that is the measurement target, thereby more reliably preventing the noise light from the noise generation point X from being incident on the optical fiber for light reception 17. Accordingly, it is possible to measure the Raman scattering light with a higher SN ratio and to shorten time necessary for measurement. As a result, it is possible to calculate the composition and the calorific value of the sample fluid with a high response.

Further, it is also important to reduce areas of noise light generated from the first measurement window 14 and the second measurement window 15 in performing noise removal. The excitation light is incident on the surface of the second measurement window 15 to be focused such that portions of the first measurement window 14 and the second measurement window 15 irradiated with the excitation light are minimized. Accordingly, the noise light may be more efficiently shielded by the first light shielding member 18 and the second light shielding member 19. As a result, it is possible to measure the Raman scattering light with a high SN ratio.

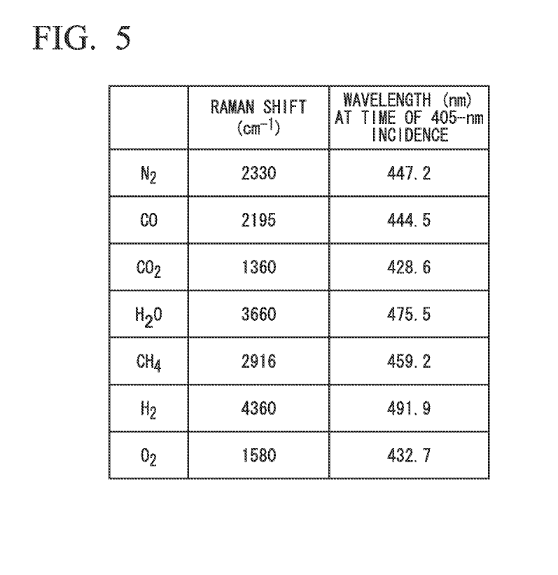

Next, a mechanism for calculating a composition and a calorific value of the fuel gas will be described in detail. FIG. 5 is a graph showing a Raman shift amount and a Raman scattering light wavelength when excitation light having a certain wavelength is incident on components of the fuel gas. As shown in FIG. 5, components contained in the fuel gas may be recognized from the Raman shift amount and concentrations of the components may be obtained from Raman scattering light intensities of wavelengths.

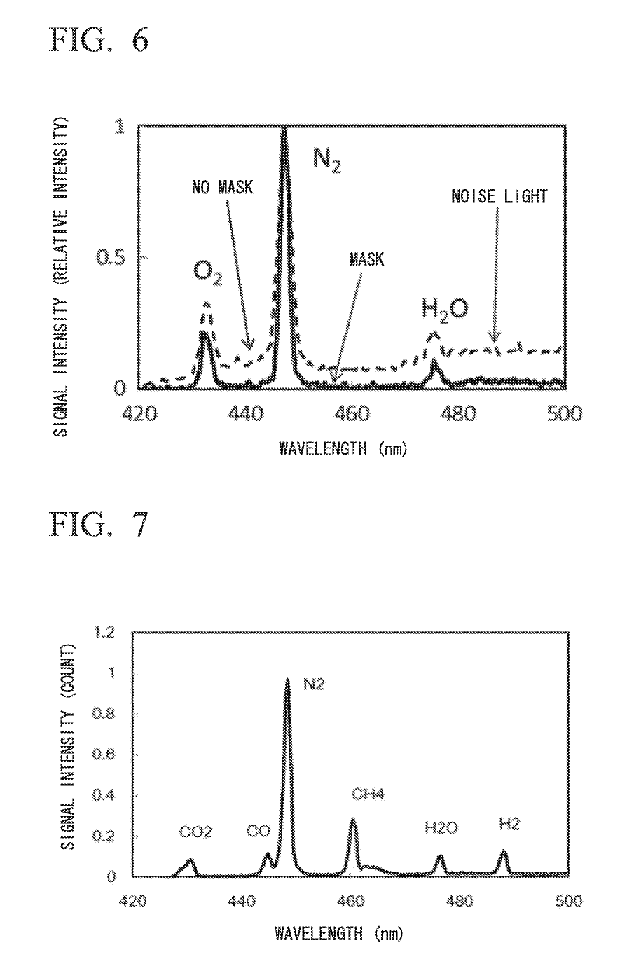

FIG. 6 is a diagram showing a comparison in a result of measuring Raman scattering light between a case in which the first light shielding member 18 and the second light shielding member 19 are provided and a case in which the first light shielding member 18 and the second light shielding member 19 are not provided, in which 405 nm-excitation light is irradiated when air is introduced into the casing 11. Raman scattering light of nitrogen (N₂: 447.2 nm), oxygen (O₂: 432.7 nm), and water vapor (H₂O: 475.5 nm) that are components in the air may be confirmed. When the first light shielding member 18 and the second light shielding member 19 are not provided, noise light other than the wavelengths of the Raman scattering light is detected. That is, as the first light shielding member 18 and the second light shielding member 19 are provided, it is possible to reduce the noise light and realize measurement with good accuracy, as may be confirmed.

Next, a method of detecting the calorific value of the fuel gas and a method of calculating the calorific value of the fuel gas will be described.

The Raman scattering light is generated by being incident the excitation light on the fuel gas. The Raman scattering light is scattering light that causes a different wavelength according to vibrational energy specific to each component in the fuel gas. Because of this, a Raman shift amount that is a difference between the wavelength of the excitation light and the wavelength of the Raman scattering light is specific to each component, as is known.

When the first measurement window 14 and the second measurement window 15 are contaminated, the intensity of the Raman scattering light having each wavelength transmitted by the optical fiber for light reception 14 is reduced. In order to correct an influence of the contamination, it is well known that relative values ICO/IN₂, ICO₂/IN₂, IH₂O/IN₂, IH₂/IN₂, and ICH₄/IN₂ which are ratios of the intensities of the Raman scattering light of the other components using IN₂, which is a Raman scattering light intensity of nitrogen (N₂), which is an example of a main component of a mixed gas, as the standard, are used. Accordingly, it is possible to reduce the influence of uncleanness of the second measurement window 15 for the Raman scattering light.

FIG. 7 shows an example of a measurement result when an excitation light having a 405 nm-wavelength is incident as incident light on a fuel gas containing carbon dioxide (CO₂), nitrogen (N₂), carbon monoxide (CO), methane (CH₄), vapor (H₂O), and hydrogen (H₂). In FIG. 7, a horizontal axis indicates the wavelength of the Raman scattering light of each component, and a vertical axis indicates a relative signal intensity obtained by normalizing each component with the intensity IN₂ of the Raman scattering light of the nitrogen component.

A calorific value of the fuel gas is known to be calculated using the relative signal intensity of the wavelength of the Raman scattering light of each component and a mole fraction of the component.

Equation (1) is an example of an equation for obtaining a higher calorific value (HHV) of the fuel gas when the fuel gas contains the above components. Further, Equation (2) is an example of an equation for obtaining a lower calorific value (LHV) of the fuel gas.

[Equation 1]

HHV=3020×CCO+3050×CH₂+9520×CCH₄ (1)

[Equation 2]

LHV=3020×CCO+2570×CH₂+8550×CCH₄ (2)

Further, the HHV denotes a calorific value (kcal/m³N) containing condensation heat of moisture in the fuel gas and moisture generated by combustion as a calorific value. The LHV denotes a calorific value (kcal/m³N) in the fuel gas that does not contain the condensation heat. Further, CN₂, CCO, CCO₂, CH₂O, CH₂, and CCH₄ denote mole fractions of components N₂, CO, CO₂, H₂O, H₂, and CH₄ obtained using Equations (3) to (8), respectively. Further, in Equations (3) to (8), α is a calibration constant of each component.

$$\begin{matrix}[ Equation 3 ] & \\ {CN}_{2} = \frac{1}{\begin{matrix}1 + α CO \cdot \frac{ICO}{{IN}_{2}} + α {CO}_{2} \cdot \frac{{ICO}_{2}}{{IN}_{2}} + \\ α {H}_{2} O \cdot \frac{{IH}_{2} O}{{IN}_{2}} + α {H}_{2} \cdot \frac{{IH}_{2}}{{IN}_{2}} + α {CH}_{4} \cdot \frac{{ICH}_{4}}{{IN}_{2}}\end{matrix}} & ( 3 ) \\ [ Equation 4 ] & \\ CCO = \frac{α CO \cdot \frac{ICO}{{IN}_{2}}}{\begin{matrix}1 + α CO \cdot \frac{ICO}{{IN}_{2}} + α {CO}_{2} \cdot \frac{{ICO}_{2}}{{IN}_{2}} + α {H}_{2} O \cdot \\ \frac{{IH}_{2} O}{{IN}_{2}} + α {H}_{2} \cdot \frac{IH}{{IN}_{2}} + α {CH}_{4} \cdot \frac{{ICH}_{4}}{{IN}_{2}}\end{matrix}} & ( 4 ) \\ [ Equation 5 ] & \\ {CCO}_{2} = \frac{α {CO}_{2} \cdot \frac{{ICO}_{2}}{{IN}_{2}}}{\begin{matrix}1 + α CO \cdot \frac{ICO}{{IN}_{2}} + α {CO}_{2} \cdot \frac{{ICO}_{2}}{{IN}_{2}} + α {H}_{2} O \cdot \\ \frac{{IH}_{2} O}{{IN}_{2}} + α {H}_{2} \cdot \frac{{IH}_{2}}{{IN}_{2}} + α {CH}_{4} \cdot \frac{{ICH}_{4}}{{IN}_{2}}\end{matrix}} & ( 5 ) \\ [ Equation 6 ] & \\ {CH}_{2} O = \frac{α {H}_{2} O \cdot \frac{{IH}_{2} O}{{IN}_{2}}}{\begin{matrix}1 + α CO \cdot \frac{ICO}{{IN}_{2}} + α {CO}_{2} \cdot \frac{{ICO}_{2}}{{IN}_{2}} + \frac{α {H}_{2} O \cdot {IH}_{2} O}{{IN}_{2}} + \\ α {H}_{2} \cdot \frac{{IH}_{2}}{{IN}_{2}} + α {CH}_{4} \cdot \frac{{ICH}_{4}}{{IN}_{2}}\end{matrix}} & ( 6 ) \\ [ Equation 7 ] & \\ {CH}_{2} = \frac{α {H}_{2} \cdot \frac{{IH}_{2}}{{IN}_{2}}}{\begin{matrix}1 + α CO \cdot \begin{matrix}ICO \\ {IN}_{2}\end{matrix} + α {CO}_{2} \cdot \begin{matrix}{ICO}_{2} \\ {IN}_{2}\end{matrix} + α {H}_{2} O \cdot \begin{matrix}{IH}_{2} O \\ {IN}_{2}\end{matrix} + \\ α {H}_{2} \cdot \begin{matrix}{IH}_{2} \\ {IN}_{2}\end{matrix} + α {CH}_{4} \cdot \begin{matrix}{ICH}_{4} \\ {IN}_{2}\end{matrix}\end{matrix}} & ( 7 ) \\ [ Equation 8 ] & \\ {CCH}_{4} = \frac{α {CH}_{4} \cdot \frac{{ICH}_{4}}{{IN}_{2}}}{\begin{matrix}1 + α CO \cdot \begin{matrix}ICO \\ {IN}_{2}\end{matrix} + α {CO}_{2} \cdot \begin{matrix}{ICO}_{2} \\ {IN}_{2}\end{matrix} + α {CO}_{2} \cdot \begin{matrix}{IH}_{2} O \\ {IN}_{2}\end{matrix} + \\ α {H}_{2} \cdot \begin{matrix}{IH}_{2} \\ {IN}_{2}\end{matrix} + α {CH}_{4} \cdot \begin{matrix}{ICH}_{4} \\ {IN}_{2}\end{matrix}\end{matrix}} & ( 8 )\end{matrix}$$

The relative intensity values ICO/IN₂, ICO₂/IN₂, IH₂O/IN₂, IH₂/IN₂, and ICH₄/IN₂ with respect to the nitrogen component IN₂ are calculated from intensities of the Raman scattering light derived from the components N₂, CO, CO₂, H₂O, H₂, and CH₄ in the fuel gas divided by the spectral calculation means 21. Further, the spectral calculation means 21 calculates the calorific value HHV (or LHV) of the fuel gas using the calculated relative intensity values ICO/IN₂, ICO₂/IN₂, IH₂O/IN₂, IH₂/IN₂, and ICH₄/IN₂ of the components and Equations (1) to (8) described above. Thus, the calorific value HHV (or LHV) of the fuel gas guided to the gas turbine 2 (see FIG. 1) is calculated.

It is possible to know the calorific value of the fuel gas in a short amount of time by measuring the calorific value of the fuel gas using the calorific value measurement device according to the present embodiment.

Information of the obtained calorific value of the fuel gas is sent to the control device 7 configured to control the operation of the power plant. For example, when the calorific value of the fuel gas is smaller than a predetermined value, the control device 7 mixes the fuel gas with an appropriate COG to increase the calorific value of the fuel gas or changes a control setting value of the gas turbine 2 into a value suitable for operation with a fuel gas having a low calorific value. Accordingly, excessive supply of a fuel gas having a high calorific value among fuel gases supplied to the combustor may be controlled. Alternatively, the calorific value may be controlled using only a fuel gas having a low calorific value without using the fuel gas having the high calorific value. Accordingly, it is possible to reduce an operation cost of the BFG-fired composite power plant (gas-fired power plant) 1.

While the first embodiment of the present invention has been described above, various modifications may be made without departing from the spirit or scope of the present invention.

For example, the example in which the second light shielding member 19 is provided has been shown in the first embodiment. However, it is possible to achieve a sufficient noise light removal effect and obtain a device having a simpler configuration without providing the second light shielding member 19.

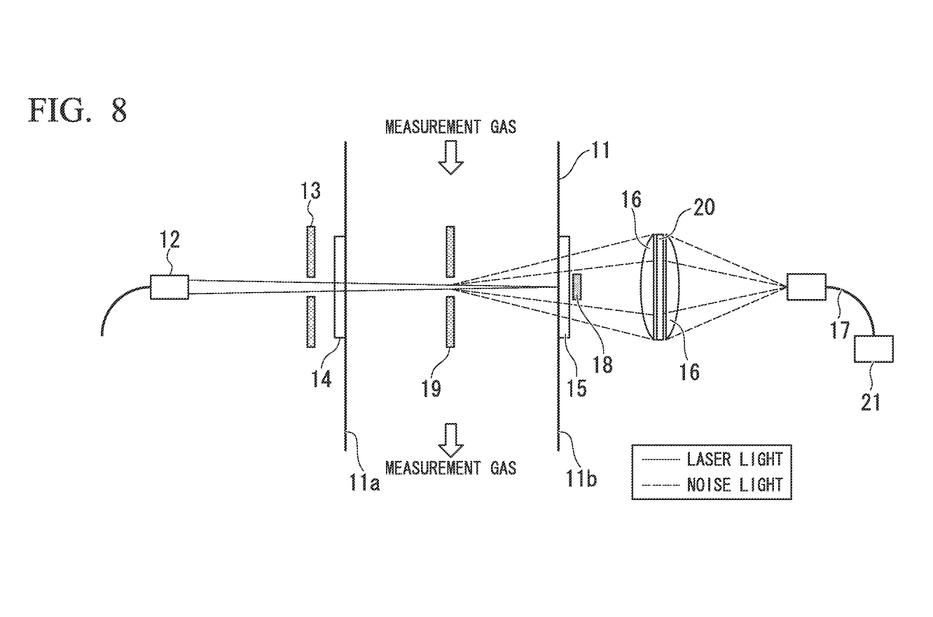

Next, a calorific value measurement device according to a second embodiment of the present invention will be described with reference to FIG. 8. Further, a description of the same parts as those in the first embodiment is omitted.

The calorific value measurement device according to the second embodiment of the present invention is an example in which the first light shielding member 18 and the second light shielding member 19 are installed in the rear of the second measurement window 15 (the first light shielding member 18) and between the first measurement window 14 and the second measurement window 15 (the second light shielding member 19), respectively. The second light shielding member 19 shields portions other than an optical path for excitation light and removes noise light from the first measurement window 14. On the other hand, the first light shielding member 18 is a member that has a light shielding area coaxial with the optical path for the excitation light and removes noise light from the second measurement window 15. With this configuration, it is possible to obtain the same noise light removal effect as the configuration of the measurement unit of the first embodiment shown in FIG. 3.

While the second embodiment of the present invention has been described, various modifications may be made without departing from the spirit or scope of the present invention.

For example, the two light shielding members are provided in the second embodiment. However, three light shielding members may be provided by adding the second light shielding member 19 of the first embodiment.

1. A fluid composition analysis mechanism comprising:
a light source configured to irradiate excitation light to a sample fluid at a measurement position;
a light receiving unit arranged on an extended line of the excitation light and configured to receive and disperse Raman scattering light generated from the sample fluid irradiated with the excitation light;
a Raman scattering light collection optical system arranged on an optical path for the excitation light or on the extended line of the excitation light and configured to collect the Raman scattering light generated at the measurement position and to cause the Raman scattering light to be incident on the light receiving unit;
a calculation unit configured to calculate a composition of the sample fluid based on an output of the light receiving unit; and
a light shielding member arranged on the optical path for the excitation light or on the extended line of the excitation light.

2. The fluid composition analysis mechanism according to claim 1, further comprising:
a first measurement window arranged on the optical path for the excitation light and configured to guide the excitation light to an area in which the sample fluid flows; and
a second measurement window arranged on the optical path for the excitation light or on the extended line of the excitation light and configured to guide the Raman scattering light generated at the measurement position to the Raman scattering light collection optical system arranged outside the area in which the sample fluid flows,
wherein the light shielding member includes:
a first light shielding member arranged on the side of the light receiving unit in comparison to a surface of the second measurement window exposed to the sample fluid; and
a second light shielding member arranged on the side of the light receiving unit in comparison to the first light shielding member and configured to have an outline coincides with the first light shielding member when viewed from the measurement position.

3. The fluid composition analysis mechanism according to claim 1, further comprising:
a first measurement window arranged on the optical path for the excitation light and configured to guide the excitation light to an area in which the sample fluid flows; and
a second measurement window arranged on the optical path for the excitation light or on the extended line of the excitation light and configured to guide the Raman scattering light generated at the measurement position to the Raman scattering light collection optical system arranged outside the area in which the sample fluid flows,
wherein the light shielding member includes:
a first light shielding member arranged between the first measurement window and the second measurement window and configured to shield portions other than the optical path for the excitation light; and
a second light shielding member arranged on the side of the light receiving unit in comparison to a surface of the second measurement window exposed to the sample fluid and configured to have a light shielding area coaxial with the optical path for the excitation light.

4. The fluid composition analysis mechanism according to claim 1, wherein:
in the light source, a focus of the excitation light is located on the surface of the member contacting the sample fluid.

5. The fluid composition analysis mechanism according to claim 1, further comprising:
a reflector provided perpendicularly to the optical path for the excitation light on the optical path and configured to reflect the excitation light.

6. A calorific value measurement device comprising:
the fluid composition analysis mechanism according to claim 1; and
a calorific value calculation mechanism configured to calculate a calorific value of the sample fluid based on information of a composition of the sample fluid output by the fluid composition analysis mechanism.

7. A power plant that is operable with a fuel gas as a fuel, the power plant comprising:
the calorific value measurement device according to claim 6; and
a control device configured to control operation of the power plant based on information of the calorific value of the fuel gas output by the calorific value measurement device,
wherein at least part of the fuel gas is guided as the sample fluid to the calorific value measurement device.

8. A calorific value measurement device comprising:
the fluid composition analysis mechanism according to claim 2; and
a calorific value calculation mechanism configured to calculate a calorific value of the sample fluid based on information of a composition of the sample fluid output by the fluid composition analysis mechanism.

9. A calorific value measurement device comprising:
the fluid composition analysis mechanism according to claim 3; and
a calorific value calculation mechanism configured to calculate a calorific value of the sample fluid based on information of a composition of the sample fluid output by the fluid composition analysis mechanism.

10. A calorific value measurement device comprising:
the fluid composition analysis mechanism according to claim 4; and
a calorific value calculation mechanism configured to calculate a calorific value of the sample fluid based on information of a composition of the sample fluid output by the fluid composition analysis mechanism.

11. A calorific value measurement device comprising:
the fluid composition analysis mechanism according to claim 5; and
a calorific value calculation mechanism configured to calculate a calorific value of the sample fluid based on information of a composition of the sample fluid output by the fluid composition analysis mechanism.
